(19) United States
(12) Patent Application Publication
(10) Pub. No.: US 2018/0310546 A1
(43) Pub. Date: Nov. 1, 2018

(54) Telescopic Seat Assembly for a Hunting Tree Stand

(71) Applicant: Richard Pope, Lexington, SC (US)

(72) Inventor: Richard Pope, Lexington, SC (US)

(21) Appl. No.: 15/616,376

(22) Filed: Jun. 7, 2017

Related U.S. Application Data
(63) Continuation-in-part of application No. 15/581,083, filed on Apr. 28, 2017, now Pat. No. 9,986,732.

(51) Int. Cl. A01M 31/02; A47C 9/10; A47C 3/40

(52) U.S. Cl. CPC A01M 31/02; A47C 3/40; A47C 9/10

(57) ABSTRACT

A collapsible hunting tree stand includes a telescopic seat arrangement so that the height of the seat may be adjusted by hand, without requiring tools, to any desired height.

### BACKGROUND OF THE INVENTION

The present invention relates generally to tree stands used for hunting game. More specifically, the present invention includes a tree stand that may be secured to a tree, and which includes a standing platform and a telescopic seat assembly, so that a hunter may choose to be in a standing position, a standard sitting position, or an elevated sitting position.

Over the years, many different types of hunting tree stands and deer stands have been developed for hunting game. Some of the more popular tree stands are collapsible, so that they may be transported in a vehicle to a designated hunting location in a collapsed state, and then may be affixed or secured to a tree in an open, operational position. These tree stands typically include a standing platform and a seat, so that a hunter may stand or sit while hunting.

The following references serve as examples of various types of tree stands used for hunting, and are hereby incorporated herein by reference.

U.S. Pat. No. 4,458,782

A seat assembly particularly adapted for support upon the inclined side frame members of the Baker tree stand (U.S. Pat. No. 3,460,649). The seat assembly includes an elongated seat member transversely spanning the side frame members and being provided with depending legs resting upon the side frame members, and a pair of hanger straps affixed to the opposite ends of the seat member and projecting upward and rearward, and pin members selectively and detachably connecting the upper ends of the hanger members, behind the seat member, to a set of longitudinally spaced bolt holes in the side frame members.

### U.S. Publication No. 20070261919A1

An adjustable tree stand for mounting and supporting a hunter in a tree a distance above the ground. The tree stand system includes a tree-engaging frame with a pair of spaced apart, normally upright members each having opposed, upper and lower ends and a cross member located between the upright members. In addition, the system includes a seat assembly, a platform, a pair of spaced cable members and a strap connected to the upright members of the frame. The seat assembly is mounted on the frame and has a seat for a hunter to sit on. The assembly is generally movable between an operative and a folded position, providing a supporting structure with a pair of supper, spaced components that project generally horizontally rearwardly for engagement with the tree when the seat assembly is in the operative position. The seat assembly includes an elongated, longitudinally extensible and retractable strut interconnecting the cross member and the seat for supporting the seat in a generally horizontal orientation when the strut is extended to a desired position. The platform is pivotally mounted to the lower ends of the upright members and the cable pair interconnects the platform and the frame allowing for movement between a folded, stored position and an operational position where the cables tensionally hold the platform. The platform also has a pair of lower, spaced components that project generally horizontally rearwardly for engagement with the tree when the platform is in the operational position. The strap connects the upright members of the frame and is adapted to embrace the tree trunk, holding the upper and lower spaced components against the tree, whereby the components and strap secure the tree stand to the tree during use.

U.S. Pat. No. 9,516,874

A hunting tree stand is disclosed. The hunting tree stand includes a backbone configured to be secured to a tree, an inner radial support beam having a generally are shape, and a plurality of cantilevered supports extending outwards from the inner radial support beam. In addition, the hunting tree stand includes a pair of adjustment plates disposed on a respective proximate end of the plurality of cantilevered supports and configured to be secured to opposing sides of a lower end of the backbone. A plurality of adjustment apertures are disposed in a curvilinear pattern on the pair of adjustment plates, where the plurality of adjustment apertures are positioned so that an angle of a decking to the backbone can be adjusted relative to the backbone by rotating the decking downwards or upwards and inserting an adjustment pin through a desired adjustment aperture and the lower end of the backbone.

U.S. Pat. No. 8,522,920

A tree stand that contains a y-axis frame adjustable along the y-axis, x-axis frame adjustable along the x-axis, and z-axis frame adjustable along the z-axis. In use, at least one securing strap secures the y-axis frame to a tree. To adjust the y-axis frame along the y-axis, the securing strap is loosened and the y-axis frame can be repositioned almost anywhere along the tree that will support the tree stand. To adjust the x-axis frame along the x-axis, the x-axis frame can be rotated around a rotational support means on the y-axis. To adjust the z-axis frame along the z-axis, a z-axis frame support is attached to the x-axis and connects to one of at least two z-axis adjustment means on the x-axis.

U.S. Pat. No. 6,866,120

A portable tree stand for use with non-vertical trees provides standing and seating platforms that may remain parallel and may be adjustable. Adjustments include a slidable seat platform and a slidable standing platform that may be extended to allow adequate seating and standing space to compensate for tree trunks that diverge from the vertical. Additionally, the distance, or height, between the standing platform and the seating platform maybe varied. A threaded chain tensioner tightens a chain around the tree helping hold the stand to the tree, and optionally a tree screw secures attachment to the tree trunk. An adjustable seat support post establishes a parallelogram relationship between the seat platform and the standing platform such that an angular relationship, which may be parallel or non-parallel, may be maintained between the seat platform and the standing platform.

U.S. Pat. No. 6,102,158

A portable tree stand capable of being erected and leveled within a leaning tree is provided. The stand comprises a tree engaging support member which is pivotally connected to the frame of the stand. This arrangement allows the seat and platform of the stand to be adjusted to a level position when erected in a leaning tree where the direction of the lean of the tree is sideways with respect to the erected stand. A back rest is also provided to give support to the hunter.

Although some of the deer stands disclosed in the above references include adjustable seats, the adjustments are difficult to make, require tools, and further, are made more difficult in the presence of game that may be nearby. There are times when a hunter, and particularly a bow hunter, needs to quietly get himself into a standing position, or at least close to a standing position, when a deer or other game is nearby, in order to be ready to take a shot. Furthermore, after the hunter is in a standing position, particularly when he has sighted game that is not yet close enough to shoot, he may have to remain in the standing position for some time before the game ventures close enough to take a shot. It would be desirable, therefore, to provide a deer stand with a seating mechanism that would allow a hunter to sit or lean in an elevated position, so that he is in a better position to take the shot when the opportunity presents itself. Additionally, it would be desirable for the hunter to be able to adjust the seat from a conventional sitting position to an elevated sitting/leaning position quickly and quietly in the presence of game, without making noise or fumbling with adjustment mechanisms. Lastly, it would also be desirable for the hunter to be able to collapse or fold the tree stand to make it easier to transport. However, none of the prior inventions disclose a collapsible tree stand that includes a telescopic seating arrangement that may be operated easily and quietly while a hunter is in the stand.

### BRIEF SUMMARY OF THE INVENTION

In accordance with one aspect of the invention, a tree stand includes a standing platform, a support structure pivotally attached to the standing platform, and a seat assembly telescopically attached to the support structure. The seat assembly includes a seat member affixed to a seat post which telescopically engages the support structure. When the tree stand is secured to a tree, the seat assembly may be disposed at a particular height above the standing platform so that the seat assembly allows the hunter to sit in a normal sitting position. Alternatively, the seat assembly may be disposed at an elevated height above the standing platform to provide an elevated seating or leaning position for the hunter.

In a preferred embodiment, the tree stand is collapsible, so that the support structure may pivot into a position that is generally parallel with the standing platform, and the seat assembly may also fold in such a way that it is generally in parallel relation to the standing platform. A user may fold the tree stand into the collapsed state for transport and storage of the tree stand, and then may unfold it for use in a tree.

The tree stand also includes means of attachment to a tree, which may comprise one or more adjustable and/or cinch straps, chains, or the like. Further, the seat assembly also preferably includes temporary securing means to allow the height of the seat assembly above the standing platform to be adjusted and a desired height to be maintained temporarily.

### BRIEF DESCRIPTION OF THE DRAWINGS

These and other features, aspects, and advantages of the present invention will become better understood with regard to the following description, appended claims, and accompanying drawings where:

FIG. 1 is a perspective view of one embodiment of a telescopic seat assembly for a hunting tree stand, showing a seat member that is fixed by a seat post clamp in a contracted position with respect to the support structure and standing platform generally associated with a user in a conventional seated position;

FIG. 2 is a perspective view of one embodiment of a telescopic seat assembly for a hunting tree stand, showing a seat member fixed by a seat post clamp in an elevated position with respect to the support structure and standing platform generally associated with a user in a leaning or elevated seated position;

FIG. 3 is a side view of one embodiment of a telescopic seat assembly for a hunting tree stand, showing a seat member fixed by a locking button in a contracted position with respect to the support structure and standing platform generally associated with a user in a conventional seated position;

FIG. 4 is a side view of one embodiment of a telescopic seat assembly for a hunting tree stand, showing a seat member fixed by a locking button in an elevated position with respect to the support structure and standing platform generally associated with a user in a leaning or elevated seated position;

FIG. 5 is a side view of one embodiment of a hunting tree stand having a telescopically adjustable seat assembly, wherein the hunting tree stand is shown in a collapsed position;

FIG. 6 is a side view of one embodiment of a telescopic seat assembly for a hunting tree stand, showing a seat member fixed in an elevated position with respect to the support structure and standing platform and a user in a leaning or elevated seated position;

FIG. 7 is a side view of one embodiment of a telescopic seat assembly for a hunting tree stand, showing a seat member fixed in a contracted position with respect to the support structure and standing platform and a user in a conventional seated position; and

FIG. 8 is a perspective view of another embodiment of a telescopic seat assembly for a hunting tree stand, showing a telescopic seat assembly for a hunting tree stand, wherein the adjustment mechanism for raising and lowering the seat is shown in the magnified inset, and includes a seat post clamp that allows infinite adjustment of the height of the seat.

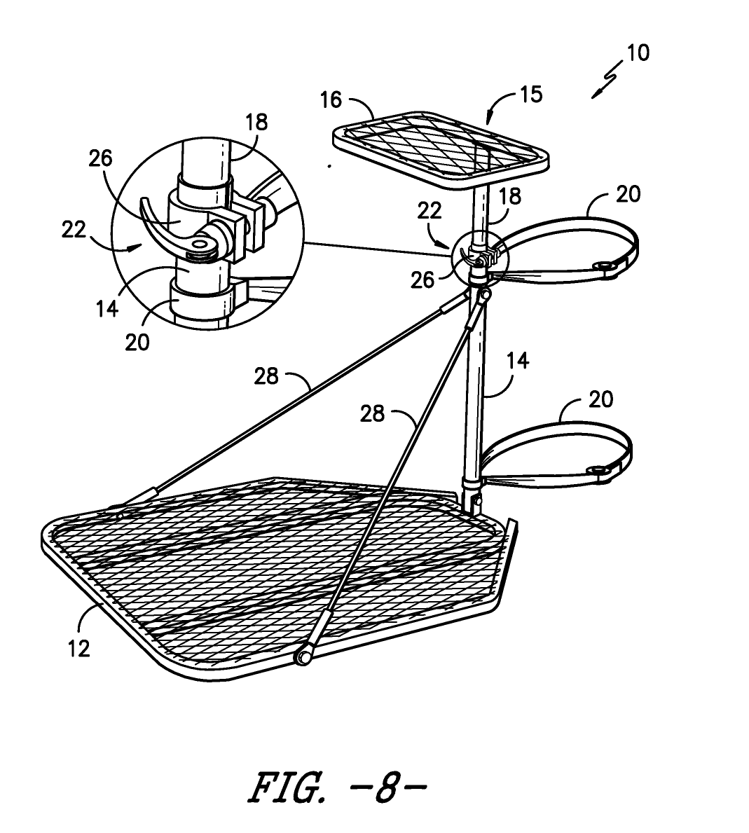

### DETAILED DESCRIPTION OF THE INVENTION

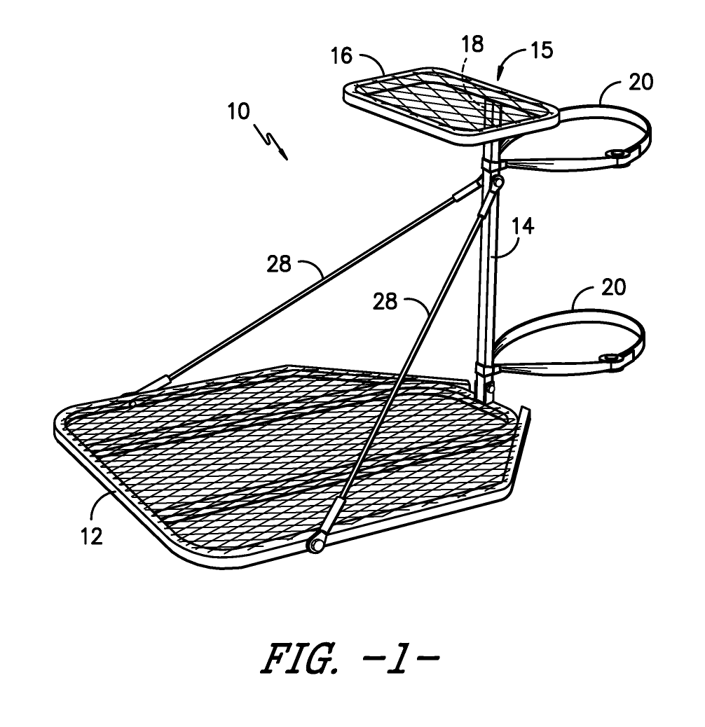

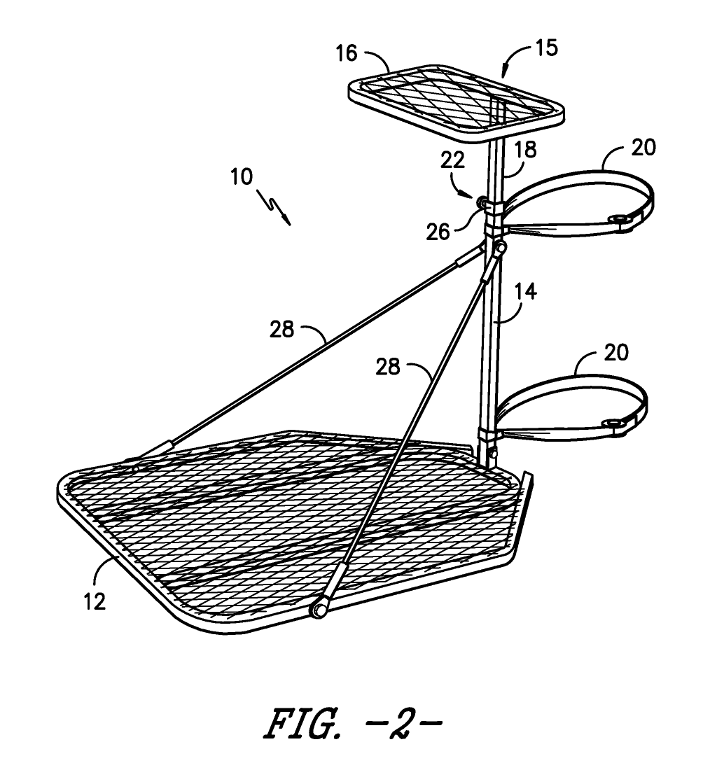

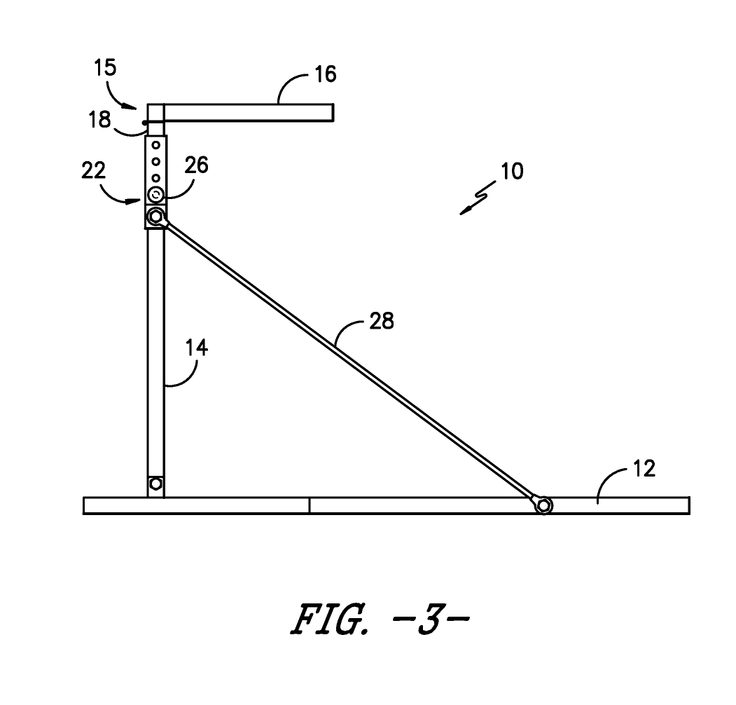

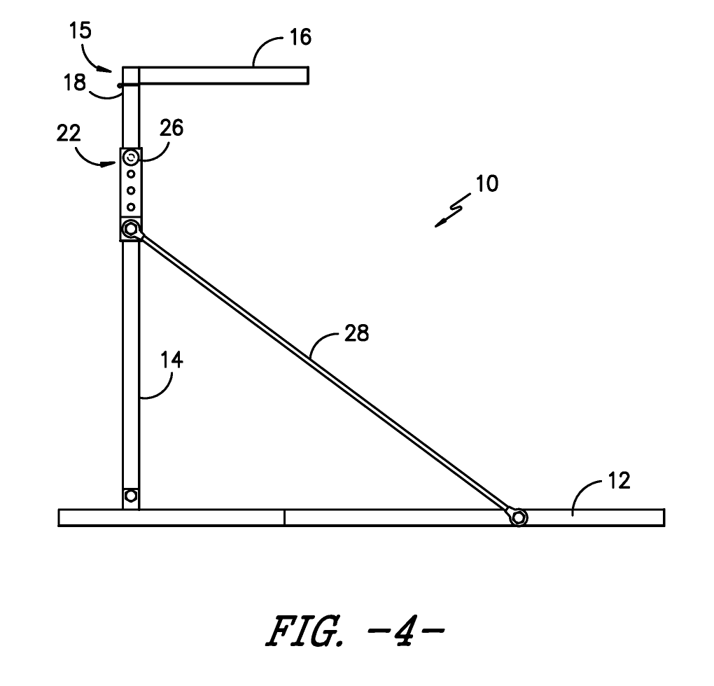

The present invention includes, in a first embodiment, a collapsible hunting tree stand 10 that includes a telescopic seat arrangement so that the seat may be positioned at a height associated with a normal, i.e. conventional, seated position or the seat may be in an elevated seating/leaning position. The tree stand 10 includes, in a preferred embodiment, a standing platform 12, a support structure 14 pivotally engaged with the standing platform, and a seat assembly 15 telescopically engaged with the support structure 14. The seat assembly 15 includes a seat member 16 affixed to a seat post 18 which telescopically engages support structure 14. The seat assembly 15 may be disposed at any desired height, including a contracted position to allow a user to sit normally thereupon, as shown in FIGS. 1, 3, and 7, or an elevated position to allow a user to sit or lean thereupon, as shown in FIGS. 2, 4, and 6.

The tree stand 10 may be affixed or secured to a tree using any suitable means, including cinch straps 20, fixed straps, chains, or any other suitable method. Various methods for securing tree stands to trees are discussed in the references cited herein, and are hereby incorporated by reference. A pair of flexible support cables 28 may be attached between the support structure 14 and the standing platform 12, in order to maintain the support structure 14 and the standing platform 12 at a generally right angle during use.

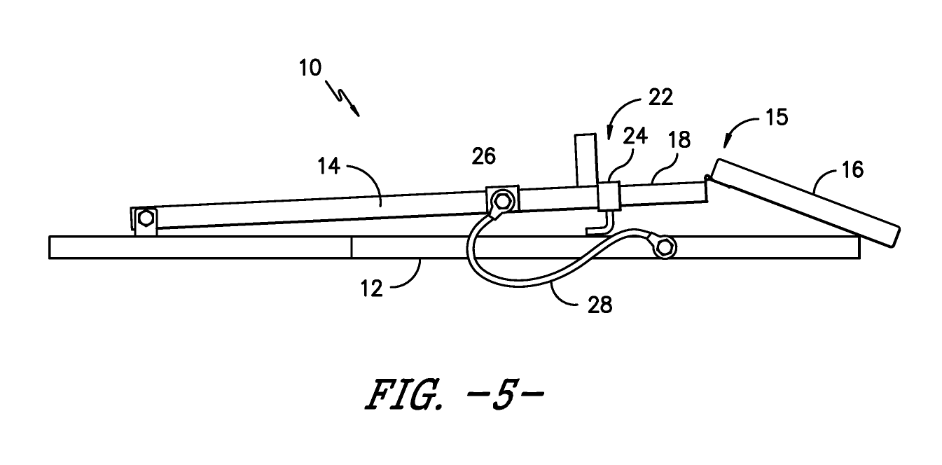

The tree stand 10 is preferably collapsible, as shown in FIG. 5, although it is contemplated that most of the components may also be fixed with respect to each other. In the collapsible embodiment, the support structure folds 14 down so that it is parallel with the standing platform 12. The seat assembly 15 may also fold into a position that is generally parallel with the standing platform 12. Advantageously, the tree stand 10 may be transported and stored in the collapsed state, and may be moved into the operational state for use in a tree. It is contemplated that any pivoting mechanism described herein may have securing means to temporarily lock the components in place, either in the operational position, or in the collapsed position, and such securing means are well-known in the art.

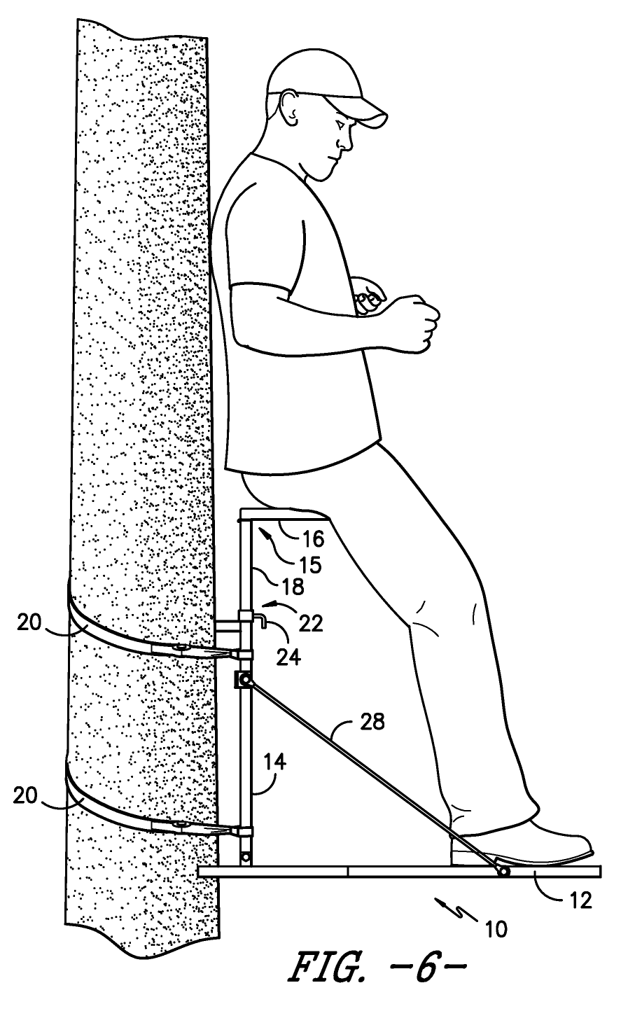

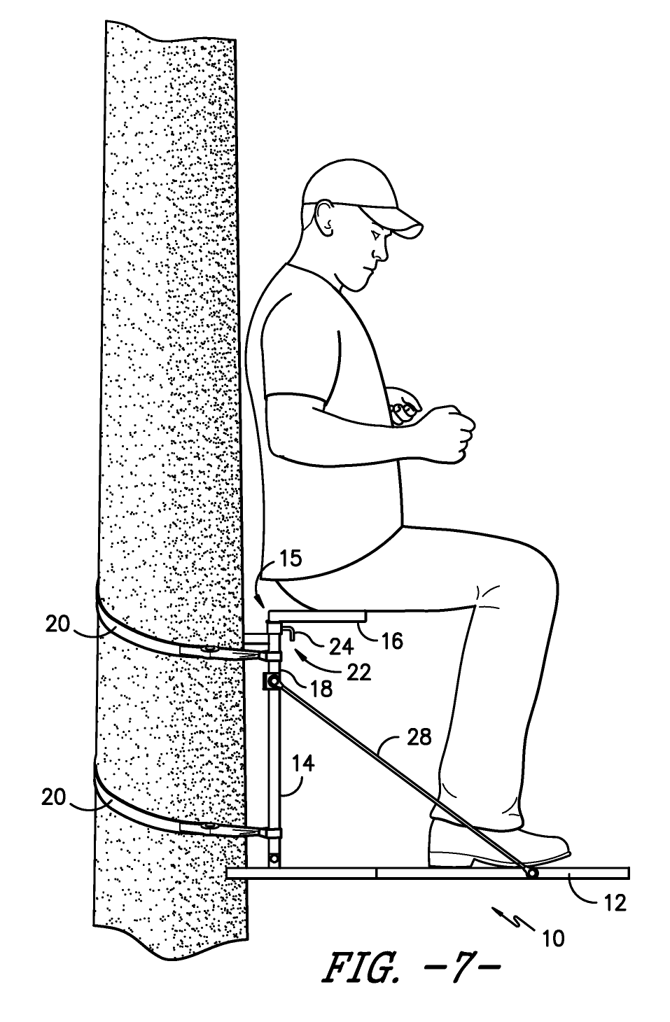

In use, when the tree stand 10 is secured to a tree, the standing platform 12 is generally parallel to the ground, and the support structure 14 is oriented in a generally vertical position. The seat assembly 15 may be disposed in a contracted position, to provide a conventional seating position for a hunter, as shown in FIG. 7. Alternatively, the seat assembly 15 may be disposed in an elevated position, to provide an elevated seating or leaning position for a hunter, as shown in FIG. 6. The hunter may either sit on the seat member 16 in this position, so that most of his weight is supported by the seat member 16, or the hunter may simply lean on the seat member 16, thereby splitting his weight between his legs/feet on the standing platform 12 and his buttocks on the seat member 16.

If a hunter is seated on the seat member 16 in a contracted position and then sees a deer or other game in the distance, he may elevate the seat member 16 up and then sit or lean thereupon, so that he is in a better position to take a shot at the game when the game comes close enough for the hunter to take a shot.

A securing mechanism 22 is used to keep the seat member 16 disposed at a desired height, as shown in FIGS. 1-4 and 6-7. The securing mechanism 22 may take many forms, but in one embodiment includes a seat post clamp 24, similar to seat post clamps commonly used to adjust the height of bicycle seats. The seat post clamp 24 is attached to the seat post 18, and when the seat member 16 is in a desired position, the seat post clamp 24 may be tightened to frictionally engage against the seat post 18 of the seat assembly 15, which provides an infinitely adjustable seat. When the seat post clamp 24 is tightened against the seat post 18, the seat post 18 is prevented from being further telescopically inserted into the support structure 14, so that the seat member 16 is locked at a desired height. In order to adjust the height of the seat, the hunter simply loosens the seat post clamp 24 allowing the seat member 16 to be raised or lowered, as desired. This arrangement allows the seat to be adjusted to any desired position, as opposed to other adjustment mechanisms that may only provide a limited number of height positions to choose from.

In an alternative embodiment, the securing mechanism 22 includes a locking button assembly 26. The locking button assembly 26 may include a spring biased button disposed along the seat post 18 which engages one of a number of holes in a portion of the support structure 14 to hold the seat member 16 at a desired height. In order to elevate the seat member 16, a hunter pushes the button to disengage it from the hole in the support structure 14 and pulls the seat member 16 upwards until the button engages a higher hole in the support structure 14. Likewise, to lower the seat member 16, the hunter pushes the button to disengage it from the hole in the support structure 14 and pushes the seat member 16 down until the button engages a lower hole in the support structure 14. It is also contemplated that other securing means, such as a locking pin and hole arrangement, may be used to keep the primary seat in a vertical position, and such securing means are well-known in the art.

Preferably, the seat adjustment mechanism does not require tools to make height adjustments to the seats, and all adjustments may be made by hand.

In another embodiment, the seat adjustment mechanism includes a locking pin that may fit through holes in the seat post and support structure. In this embodiment, the seat is adjusted by removing the locking pin, raising or lowering the seat until the hole in the seat post lines up with one of the holes in the support structure or sleeve, and then inserting the locking pin through the aligned holes to secure the seat in place. Optionally, rubber grommets may be placed around the perimeter of the holes in the support structure. This arrangement reduces the noise level during the adjustment operation by preventing the inevitable metal-on-metal clanging as the metal locking pin fits through aligned holes in the metal support structure and seat post.

Although the present invention has been described in considerable detail with reference to certain preferred versions thereof, other versions are possible. Therefore, the spirit and scope of the appended claims should not be limited to the description of the preferred versions contained herein. All features disclosed in this specification may be replaced by alternative features serving the same, equivalent or similar purpose, unless expressly stated otherwise. Thus, unless expressly stated otherwise, each feature disclosed is one example only of a generic series of equivalent or similar features.

1. A tree stand for hunting and observing game, said tree stand comprising:
a standing surface;
a support structure having an upper end and a lower end, said support structure attached to said standing surface on said lower end;
a seat assembly including a seat member attached adjacent a first end of a seat post, wherein a second end of said seat post telescopically engages said upper end of said support structure so that said seat member may be raised and lowered; and
a securing mechanism positioned on said support structure, said securing mechanism being used to temporarily maintain said seat in position at a desired height, wherein said securing mechanism may be manually operated by hand.

2. The tree stand set forth in claim 1, wherein said support structure is pivotally attached to said standing surface.

3. The tree stand set forth in claim 1, wherein said seat member is pivotally attached to said seat post.

4. The tree stand set forth in claim 1, wherein said securing mechanism allows for infinite adjustment of the height of said seat.

5. The tree stand set forth in claim 4, wherein said securing mechanism includes a seat post clamp that is attached to said seat post.

6. The tree stand set forth in claim 1, wherein said securing means includes a locking button assembly.

7. The tree stand set forth in claim 6, wherein said locking button assembly includes a spring biased button disposed on said seat post and at least one hole defined by said support structure.

8. The tree stand set forth in claim 1, wherein said securing mechanism includes a locking pin that is temporarily inserted into aligned holes defined within said seat post and said support structure.

9. The tree stand set forth in claim 8, wherein rubber grommets are disposed about a perimeter of said holes in said support structure to reduce noise while the locking pin is being inserted or removed from said holes.
